(19) United States
(12) Patent Application Publication
(10) Pub. No.: US 2007/0236836 A1
(43) Pub. Date: Oct. 11, 2007

(54) Magnetic head slider

(75) Inventors: Masayuki Kurita, Kanagawa (JP); Toshiya Shiramatsu, Kanagawa (JP); Kazuhiro Nakamoto, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/784,461

(22) Filed: Apr. 6, 2007

(30) Foreign Application Priority Data
Apr. 6, 2006 (JP) 2006-105048

(51) Int. Cl. G11B 5/60

(52) U.S. Cl. 360/234.7

(57) ABSTRACT

Embodiments in accordance with the present invention provide a thin-film head formed on an AlTiC substrate of a magnetic head slider. A thin-film head include a write element, a read element, a heater, an alumina insulating film that separates the elements and heater from one another, electric wiring films leading to the respective elements, and an alumina protective insulating film that protects all the layered films. For this configuration, in order to maximize a change in a flying height caused by heat dissipated from the heater and minimize a change in the flying height caused by heat dissipation derived from a recording current, the write element is first formed on the AlTiC substrate and the read element is formed on the write element. An adiabatic layer made of a material exhibiting low thermal conductivity may be formed between the write element and the read element and heater.

### CROSS-REFERENCE TO RELATED APPLICATION

The instant nonprovisional patent application claims priority to Japanese Patent Application 2006-105048, filed Apr. 6, 2006 and incorporated by reference in its entirety herein for all purposes.

### BACKGROUND OF THE INVENTION

Magnetic disk drives include a rotary magnetic disk and a magnetic head slider that is borne by a magnetic head supporting mechanism, which has write and read elements mounted thereon, includes a suspension, and is positioned in the radial direction of the magnetic disk. The magnetic head slider travels relative to the magnetic disk over the magnetic disk, and reads or writes magnetic information from or on the magnetic disk. The magnetic head slider flies as an air-lubricated bearing owing to a wedge film effect of air, and does not directly come into solid contact with the magnetic disk. For effective realization of a high recording density for the magnetic disk drive and for a large capacity or a compact design of the magnetic disk drive, the distance between the magnetic head slider and magnetic disk, that is, the flying height of the slider, should be decreased in order to improve a linear recording density.

In designing of the flying height of a slider, a flying height margin has been adopted due to variations caused by machining, differences in operating environmental temperature, or differences in the flying height between recording and reproducing to prevent the slider and a disk from coming into contact with each other. The employment of a slider having the capability to adjust the flying height for each head or according to operating environment makes it possible to disregard the margin and largely decrease the flying height of write and read elements while preventing the contact of the slider with the disk. For example, JP-A-2005-135501 (patent document 1) has proposed a slider structure in which a heater including a thin-film resistor is disposed near a write element and a read element. Part of a slider is heated, if necessary, so that it is thermally expanded to project; and the distance between the write element and read element is thus adjusted.

When a flying height is, as mentioned above, adjusted by utilizing thermal expansion and projection caused by a heater, a change in the flying height per a unit amount of heat dissipated from the heater should be larger. This is because when the change in the flying height per the unit amount of dissipated heat is larger, a thermal load to be imposed on a read element or the heater itself may be smaller, the ability of an LSI having the capability to supply power to the heater may be limited, and the power consumption of a disk drive may be smaller. On the other hand, heat dissipation, which is derived from a recording current that flows through a write coil, other than the heater, also causes part of a slider near the write and read elements to project. This leads to a change (decrease) in the flying height of the write and read elements. The change in the flying height caused by the heat dissipation derived from the recording current is preferably smaller. As long as a slider enjoys high reliability and high recording/reproducing performance and exhibits a small difference in the flying height between recording and reproducing without the necessity of adjusting the flying height using the heater, even when the heater is included, the power required is limited.

There are two demands, that is, a demand for maximizing the change in a flying height caused by heat dissipated from a heater and a demand for minimizing the change in the flying height caused by heat dissipation derived from a recording current. However, since the two changes in the flying height are basically attributable to the same principle of thermal projection, the two demands have a relationship of a trade-off and are hard to meet simultaneously. For example, when a base alumina layer formed initially on a substrate made of an alumina-titanium carbide ceramic (hereafter called AlTiC) is made thicker, the change in the flying height caused by heat dissipated from the heater can be increased. However, the change in the flying height caused by heat dissipation derived from the recording current gets larger accordingly.

Moreover, when a slider is designed as a stepped bearing so that a ratio of air pressure, which is generated on the air bearing surface of the slider due to the thermal projection of the slider, to the thermal projection will be small, the flying of the slider is suppressed. Consequently, the change in the flying height caused by heat dissipated by the heater can be increased. However, the change in the flying height caused by heat dissipation derived from the recording current also gets larger. There is therefore a demand for a head structure capable of simultaneously meeting the two demands without bringing about a trade-off.

### BRIEF SUMMARY OF THE INVENTION

Embodiments in accordance with the present invention provide a magnetic head slider having the capability to adjust a flying height so that a change in the flying height caused by heat dissipated from a heater can be increased, while a change in the flying height caused by heat dissipation derived from a recording current can be decreased.

In relation to a magnetic head slider in which a heater is disposed near a read element and a flying height of a head can be adjusted, there are two demands, that is, a demand for maximizing a change in the flying height caused by heat dissipated from a heater and a demand for minimizing a change in the flying height caused by heat dissipation derived from a recording current.

Embodiments in accordance with the present invention provide a thin-film head formed on a substrate of a magnetic head slider. Referring to the specific embodiment shown in FIG. 3, a thin-film head includes a write element 2, a read element 3, a heater 4, an alumina insulating film 50 that separates the elements and heater from one another, electric wiring films leading to the respective elements, and an insulating film 52 that protects all the layered films. For this configuration, in order to maximize a change in a flying height caused by heat dissipated from the heater and minimize a change in the flying height caused by heat dissipation derived from a recording current, the write element 2 is first formed on the AlTiC substrate 1a and the read element 3 is formed on the write element 2. An adiabatic layer 9 made of a material exhibiting low thermal conductivity may be formed between the write element 2 and the read element 3 and heater 4.

According to an embodiment of the present invention, in order to maximize a change in a flying height caused by heat dissipated from a heater and minimize a change in the flying height caused by heat dissipation derived from a recording current, the order of forming a write element and a read element is the reverse of the order thereof in a conventional magnetic head. Namely, the write element is formed first on an AlTiC substrate, and the read element is formed on the write element.

In one embodiment, a magnetic head slider in accordance with the present invention includes a write element formed on an element forming surface of the slider, a read element, a heater, and an insulating layer that separates the elements and heater from one another. The distance from the element forming surface of the slider to the write element is smaller than the distance from the element forming surface of the slider to the read element and heater.

In another embodiment, the magnetic head slider has an adiabatic layer, which is made of a material exhibiting low thermal conductivity and being effective in discontinuing heat transfer, interposed between the write element and heater.

For a more complete understanding of the present invention, reference is made to the following detailed description taken in conjunction with the accompanying drawings. Incidentally, the same reference numerals in the different drawings denote the same components.

### BRIEF DESCRIPTION OF THE DRAWINGS

FIG. 1 is a sectional view of an air outflow end side of a magnetic head slider according to an embodiment of the present invention.

FIG. 2 is a perspective view of the magnetic head slider according to an embodiment of the present invention which is seen from an air bearing surface thereof.

FIG. 3 is a sectional view of an air outflow end side of a magnetic head slider according to an embodiment of the present invention.

FIG. 4 is a sectional view of an air outflow end side of a conventional magnetic head slider.

FIG. 5 shows the results of simulation performed to measure a magnitude of projection caused by heat dissipation derived from a recording current.

FIG. 6 shows the results of simulation performed to measure a magnitude of projection caused by heat dissipated from a heater.

FIG. 7 shows the appearance of a magnetic disk drive in which a magnetic head slider according to an embodiment of the present invention is mounted.

### DETAILED DESCRIPTION OF THE INVENTION

Embodiments in accordance with the present invention relate to a magnetic head slider intended to realize a high recording density for a magnetic disk drive. More particularly, the present invention is concerned with a magnetic head slider having the capability to adjust the distance between a magnetic disk and a magnetic head.

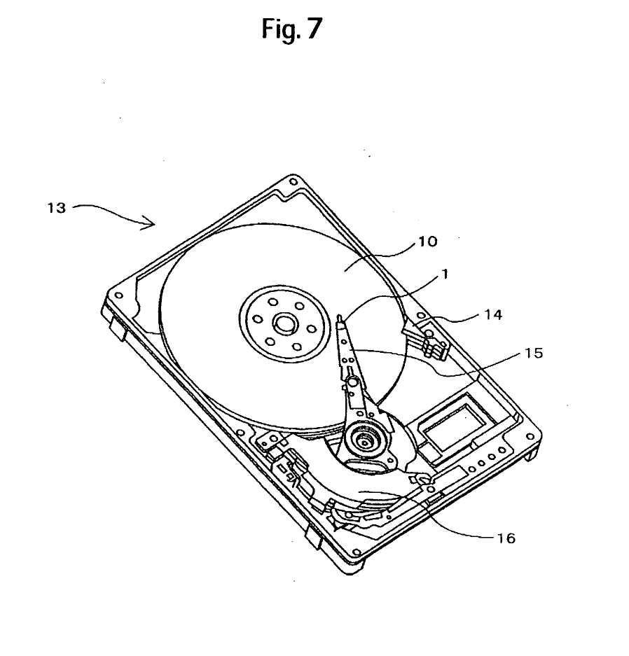

Referring to FIG. 7, the outline configuration of a magnetic disk drive in which a magnetic head slider in accordance with an embodiment of the present invention is mounted will be described below. The magnetic disk drive 13 includes a magnetic disk 10 on which magnetic information is stored and which is rotated by a spindle motor, and a magnetic head slider 1 on which write and read elements are mounted and which is borne and radially positioned by a load beam 15. The magnetic head slider 1 travels relative to the magnetic disk 10 and over the magnetic disk 10 so as to read or write magnetic information from or on the magnetic disk 10. The magnetic head slider 1 flies as an air-lubricated bearing due to the wedge film effect of air, but does not directly come into solid contact with the magnetic disk 10. In order to realize a high recording density for the magnetic disk drive 1 and a large capacity or a compact design of the magnetic disk drive, it proves effective to decrease the distance between the magnetic head slider 1 and magnetic disk 10. That is, the flying height of the slider is decreased to improve linear recording density. Recently, the flying height of the slider has been decreased down to about 10 nm or less.

The magnetic head slider 1 is attached to the blade spring-like load beam 15 and is moved toward the surface of a magnetic disk by the load beam 15. The magnetic head slider 1 performs a seek in the radial direction of the magnetic disk 10, together with the load beam 15, by means of a voice coil motor 16, whereby recording or reproducing is performed all over the surface of the magnetic disk. When the magnetic disk drive is stopped or a Read or Write instruction is not issued for a certain period of time, the magnetic head slider 1 withdraws from above the magnetic disk 10 to the top of a ramp 14. Herein, the illustrated magnetic disk drive includes a loading/unloading mechanism. Even in a contact start/stop type magnetic disk drive in which when the disk drive is stopped, the magnetic head slider 1 stands by in a specific area on the magnetic disk 10, the present invention would also prove advantageous.

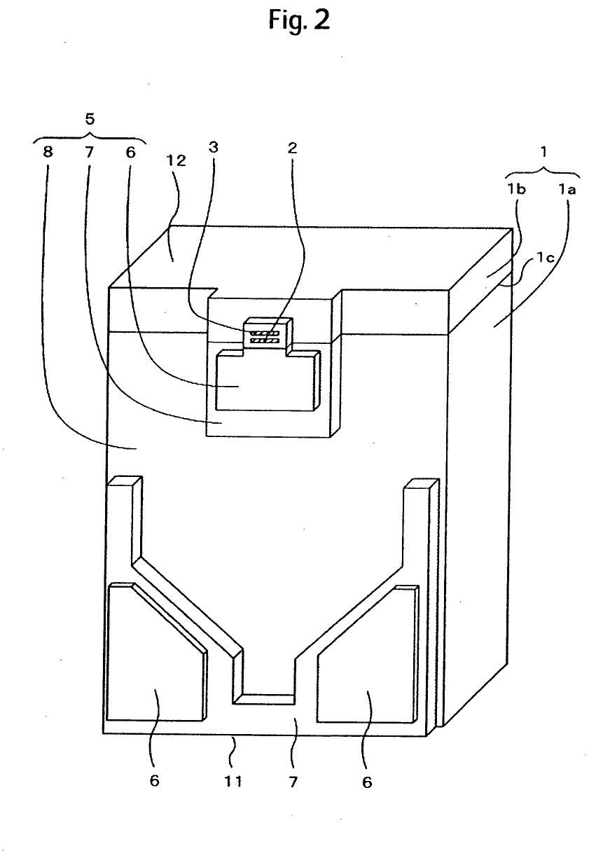

FIG. 2 is a perspective view in which the magnetic head slider 1 in accordance with an embodiment pf the present invention as seen from the air bearing surface thereof. The magnetic head slider 1 includes a substance 1a (slider) made of an alumina-titanium carbide ceramic (AlTiC) and a thin-film head 1b formed on the element forming surface 1c of the slider 1a. Processes of sputtering, plating, and polishing may be repeatedly performed on a wafer in order to layer the thin-film head 1b on the element forming surface 1c of the substrate 1a. Thereafter, bar-shaped blocks can be cut out by dicing the wafer. After predetermined machining is performed, numerous magnetic head sliders 1 are cut out of each block. The magnetic head slider 1 is typically shaped nearly like a rectangular parallelepiped. For example, in one embodiment, the magnetic head slider has a length of about 1.25 mm, a width of about 1.0 mm, and a thickness of about 0.3 mm, and has a total of six surfaces, that is, an air bearing surface 5, an air inflow end surface 11, an air outflow end surface 12, flanks, and a back. The air bearing surface 5 may be smoothened by performing polishing. Aside from the above dimensions of the slider, the dimensions of a compact slider according to another embodiment are such that the length is about 0.85 mm, the width is about 0.7 mm, and the thickness is about 0.23 mm. Even in the compact slider, the present invention would prove equally advantageous.

The air bearing surface 5 may be microscopically stepped through such a process of ion milling or etching (stepped bearing). When the air bearing surface 5 is opposed to a disk that is not shown, air pressure is generated on the air bearing surface so that the air bearing surface will fill the role of an air bearing which bears a load imposed on the back. In the drawing, the steps are exaggerated.

As mentioned above, the air bearing surface 5 is stepped and segmented into three kinds of surfaces that are substantially parallel to one another. Namely, the three kinds of surfaces include rail surfaces 6 that come closest to a disk, shallow-groove surfaces 7 that are stepped bearing surfaces and are located by a value ranging from approximately 100 nm to 200 nm more deeply than the rail surfaces 6 are, and a deep-groove surface 8 located by approximately 1 μm more deeply than the rail surfaces 6 are. An airflow derived from the rotation of a disk advances from the shallow-groove surfaces 7 on the air inflow end surface 11 side of the air bearing surface, which serve as a stepped bearing, into the rail surfaces 6 The airflow is compressed due to the narrowed channel. This results in positive air pressure. On the other hand, when an airflow advances from the rail surfaces 6 and shallow-groove surfaces 7 to the deep-groove surface 8, negative air pressure occurs due to the enlarged channel.

The magnetic head slider 1 is designed to fly in a posture causing the flying height of the air inflow end surface 11 side thereof to get larger than the flying height of the air outflow end surface 12 side thereof. Consequently, the flying pad (rail surface) 6 near the outflow end approaches a disk most closely. Near the outflow end, the rail surface 6 projects relative to the surrounding shallow-groove surface 7 and deep-groove surface 8. Unless the slider in the pitching or rolling posture tilts to a degree exceeding a certain limit, the rail surface 6 approaches the disk most closely. The write element 2 and read element 3 are formed in the portion of the rail surface 6 belonging to the thin-film head 1b. The shape of the stepped bearing is designed so that a load imposed by the load beam and the positive or negative air pressure generated on the air bearing surface 5 will be well-balanced and so that the distance from the write element 2 and read element 3 to the disk will be retained at an appropriate value equal to or smaller than about 10 nm.

Herein, a description has been made of the magnetic head slider having the two-step stepped bearing whose air bearing surface 5 is composed of three kinds of surfaces 6, 7, and 8 that are substantially parallel to one another. The present invention will prove equally advantageous even when applied to a magnetic head slider having a three or more-step stepped bearing composed of four or more kinds of parallel surfaces.

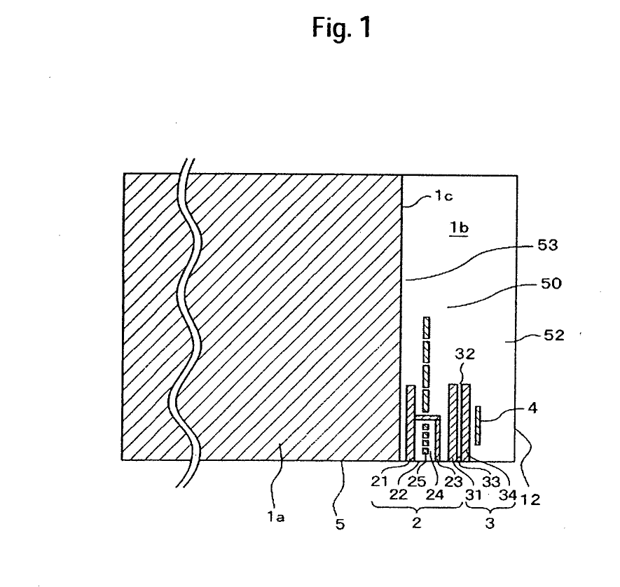

FIG. 1 is a sectional view of the air outflow end surface 12 side of the magnetic head slider 1 according to an embodiment of the present invention. FIG. 4 is a sectional view of the air outflow end surface 12 side of a conventional magnetic head slider. As shown in FIG. 1, the thin-film head 1b, which is layered on the element forming surface 1c of the AlTiC substrate 1a, includes the write element 2, read element 3, heater (heating element) 4, a ceramic (alumina in this case) insulating layer 50 that separates the write and read elements and heater from one another, and electric wiring films (not shown) leading to the respective elements.

In one embodiment, the write element 2 includes a lower magnetic pole 21, an upper magnetic pole 23 that forms a magnetic gap 22 on the side of the air bearing surface and has the rear part thereof magnetically coupled to the lower magnetic pole 21, and a coil 25 formed between the lower magnetic pole 21 and upper magnetic pole 23 with an interlayer insulating layer 24 among them. In one embodiment, the read element 3 includes a lower shield 31, a gap layer 32, a magnetoresistive element 33 formed in the gap layer 32, and an upper shield 34. In some embodiments, the magnetoresistive element 33 is a giant magnetoresistive (GMR) element or a tunneling magnetoresistive (TMR) element. In one aspect, the heater 4 is realized with a thin-film resistor made of a permalloy and is disposed above (near) the read element 3.

In efforts to maximize a change in a flying height caused by heat dissipated from the heater while minimizing a change in the flying height caused by heat dissipation derived from a recording current, the order of forming the write element 2 and read element 3 in an embodiment of the present embodiment is the reverse of the order in which those of a conventional magnetic head are formed. A difference of the embodiment shown in FIG. 1 from a related art shown in FIG. 4 lies in a point that the read element 3 and write element 2 included in the related art are formed in that order so that the read element 3 will get closer to the substrate 1a, while the write element 2 and read element 3 included in the present embodiment are formed in that order so that the write element will get closer to the substrate 1a. Namely, the write element 2 is formed first on the AlTiC substrate 1a, and the read element 3 is formed on the write element 2.

The AlTiC substrate 1a is superior in thermal conduction compared with other materials such as alumina used to form the magnetic head, and absorbs or disperses a large amount of heat. When the write element 2 is disposed closer to the AlTiC substrate 1a than the one included in a conventional magnetic head is, heat dissipated due to a recording current near the write element 2 is quickly absorbed by the substrate 1a. Thermal projection derived from the recording current can be reduced compared with thermal projection of the conventional magnetic head. Moreover, when the heater 4 is disposed farther away from the AlTiC substrate 1a than it is in the conventional magnetic head, heat dissipated from the heater is prevented from escaping into the substrate 1a. The thermal projection per a unit amount of heat dissipated from the heater can be increased compared with that of the conventional magnetic head.

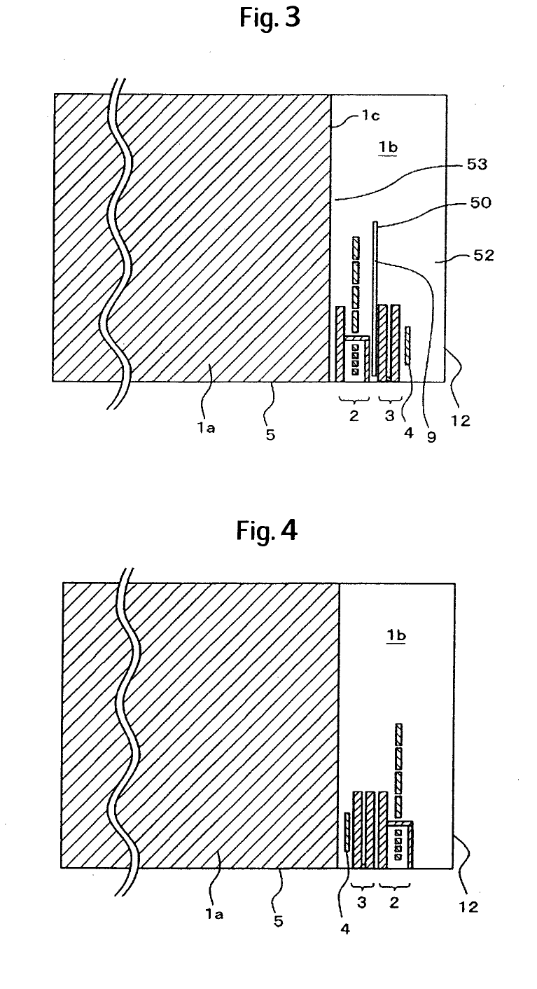

FIG. 3 is a sectional view of the air outflow end surface 12 side of a magnetic head slider 1 in accordance with an embodiment of the present invention. In this embodiment, an adiabatic layer 9 made of a material exhibiting lower thermal conductivity than the material of the surrounding alumina insulating layer 50 is interposed between the heater 4 and read element 3 and the write element 2 for the purpose of suppressing heat transfer. A role of the adiabatic layer 9 is to transfer heat, which is dissipated due to a recording current, to the substrate 1a as much as possible without transferring it to the outflow end of the slider (rightward in the drawing) so that the slider will be cooled as quickly as possible in order to minimize the thermal projection of the slider. Additionally, heat dissipated from the heater 4 is not transferred to the substrate 1a (leftward in the drawing) so that a larger amount of heat will stay on the outflow end of the slider (rightward in the drawing). Thus, the projection of the slider caused by heat dissipated from the heater is increased.

Specifically, the adiabatic layer 9 fills the role of amplifying the advantage provided by forming the write and read elements in reverse order from the order in which those included in the conventional head structure are formed. When the write and read elements are formed in conventional order, that is, when the read element 3 is first formed on the AlTiC substrate 1a and the write element 2 is formed on the read element 3, even if the adiabatic layer 9 is interposed between the write element 2 and read element 3 (and heater 4), no advantage is won. On the contrary, heat dissipated due to a recording current is increased, but the projection caused by heat dissipated from the heater is decreased. Examples of a material exhibiting low thermal conductivity include silicon dioxide and a resin.

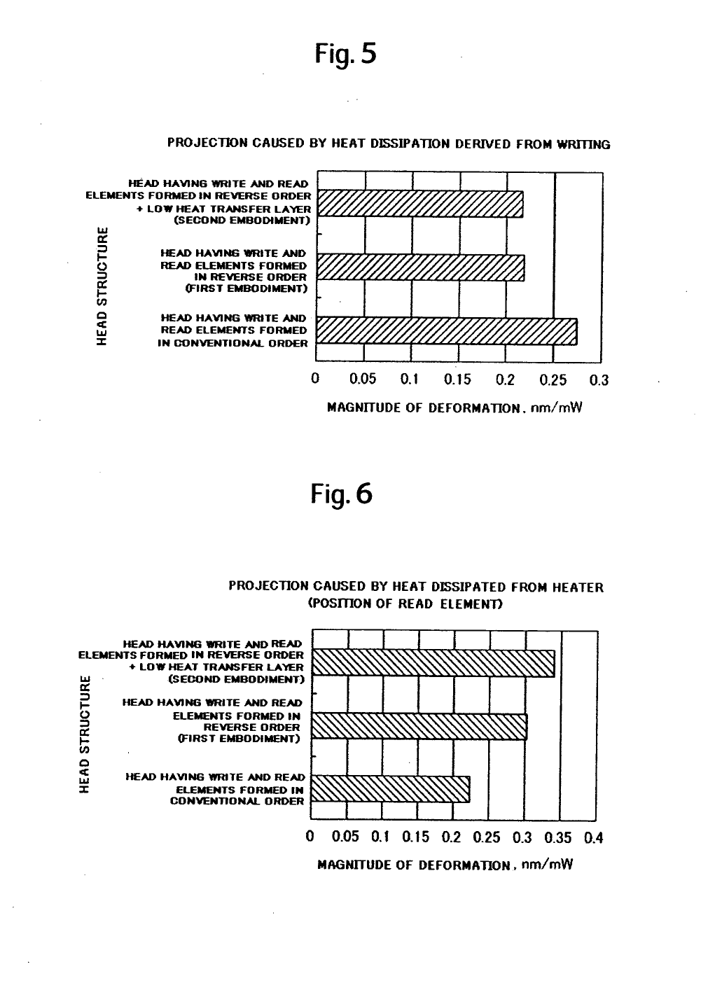

FIG. 5 and FIG. 6 show the advantages of embodiments of the present invention using values calculated through heat transfer simulation and deformation simulation. Shown are a magnitude of projection derived from a recording current and a magnitude of projection occurring at the position of the read element due to heat dissipated from the heater. Herein, a magnetic head slider having a conventional structure, the magnetic head slider 1 in accordance with the first embodiment of FIG. 1, and the magnetic head slider 1 in accordance with the second embodiment of FIG. 3, are compared with one another. As shown in FIG. 5, as for the thermal projection caused by heat dissipation derived from the recording current, the thermal projection observed in the first embodiment is smaller than the thermal projection observed in the conventional structure. From this viewpoint, the first embodiment is superior to the conventional structure. Moreover, the thermal projection observed in the second embodiment is smaller than the thermal projection observed in the first embodiment. From this perspective, the second embodiment is superior to the first embodiment.

As shown in FIG. 6, as for the magnitude of projection occurring at the position of the read element due to heat dissipated from the heater, the thermal projection observed in the first embodiment is larger than the thermal projection observed in the conventional structure. From this viewpoint, the first embodiment is superior to the conventional structure. Moreover, the thermal projection observed in the second embodiment is larger than the thermal projection observed in the first embodiment. From this viewpoint, the second embodiment is much superior to the first embodiment.

Incidentally, the position of the heater 4 is shown in FIG. 1 and FIG. 3 to be above the read element 3 (right side of the drawing). Alternatively, the position of the heater 4 may be behind the read element 3 (upper side of the drawing). As long as the heater is located in the vicinity of the read element 3, the heater 4 may be disposed everywhere. Nevertheless, an advantage of embodiments of the present invention is gained.

Next, a method of forming the thin-film magnetic head 1b on a wafer according to an embodiment of the present invention will be described below. First, an under insulating layer 53 made of alumina or the like is formed on the wafer. Thereafter, the lower magnetic pole 21 of the write element 2 is formed on the under insulating layer 53, and the magnetic gap film 22 made of alumina or the like and the upper magnetic pole 23 of the write element 2 are formed. Moreover, the coil 25 through which a current for causing the upper magnetic pole 23 to induce a magnetic field flows, a recording lead line led out of the coil 25, and the insulating film 24 encircling the coil 25 are formed. The lower magnetic pole 21 and upper magnetic pole 23 are magnetically interconnected in a back gap (deep end).

Thereafter, the lower shield 31 is formed via the insulating layer 50 made of alumina or the like, and the (lower) gap layer 32 made of alumina or the like is formed. Furthermore, the magnetoresistive element 33 that is a major part of the read element 2 and a pair of electrodes (not shown) for use in drawing out a magnetic signal from the magnetoresistive element 33 are formed. Thereafter, the (upper) gap layer 32 made of alumina or the like and the upper shield 34 are formed. Furthermore, the insulating layer 50 made of alumina or the like is formed.

Thereafter, the heater 4 realized with a metallic thin-film resistor and a lead line (not shown) over which a current flows into the heater 4 are formed. For example, a thin line whose material is a permalloy, whose thickness is about 0.5 μm, and whose width is about 4.5 μm is laid tortuously in an area having a depth of about 60 μm and a width of about 60 μm, and the space in the area is filled with alumina. This results in a resistance of approximately 50Ω.

Thereafter, a protective insulating layer 52 made of alumina or the like and intended to protect and isolate the foregoing elements is formed to cover all of the layered elements. Finally, a terminal (not shown) of the write element 2 via which a current externally flows into the coil 25, a terminal (not shown) of the read element 3 via which a magnetic signal is transmitted externally, and a terminal (not shown) of the heater 4 via which a current externally flows into the heater 4 are formed.

In the case of the second embodiment shown in FIG. 3, the adiabatic layer 9 is interposed between the write element 2 and read element 3. According to another embodiment of the present invention, after the write element 2 is formed according to the embodiment of the foregoing forming method employed in the first embodiment, the insulating layer 50 made of alumina is formed; and the adiabatic layer 9 made of a resin or silicon dioxide is formed on the insulating layer 50 so that it will be large enough to cover the entire write element 2. Thereafter, the insulating layer 50 made of alumina is formed on the adiabatic layer 9. Thereafter, similarly to the forming method employed in the first embodiment, the read element 3, heater 4, and protective insulating layer 52 are formed.

Next, a process during which individual magnetic head sliders 1 are cut out of a wafer and a process during which the magnetic head slider is mounted in a magnetic disk drive according to embodiments of the present invention will be described below. After multiple thin-film heads 1b are formed simultaneously on the wafer, the wafer is diced into bar-like blocks. Thereafter, the cut surfaces of the blocks are polished in order to form air bearing surfaces, and then cleansed. Thereafter, a carbon protective film of several nanometers thick is formed on the air bearing surfaces for fear the air bearing surfaces may wear out due to short-time and light contact with a disk or in order to prevent the thin-film elements on the air bearing surfaces from corroding. Thereafter, the rail surfaces 6, shallow-groove surfaces 7, and deep-groove surface 8 are formed on the air bearing surfaces in order to stabilize the sliders. Each of the bar-like blocks is cut into the individual magnetic head sliders 1, and then cleansed again. Thus, the magnetic head sliders 1 are completed. Thereafter, the magnetic head sliders 1 are bonded to a gimbal that is part of a magnetic head supporting mechanism. Wiring, assembling, and cleansing are then performed. Finally, the assembly is mounted in a magnetic disk drive. Incidentally, as a magnetic recording method, either a longitudinal recording method or a vertical recording method may be adopted.

Next, a method of adjusting the flying height of the magnetic head slider in accordance with embodiments of present invention will be described below. A procedure of adjusting the flying height is broadly divided into three steps of adjustments, that is, adjustment during designing, adjustment during testing at a factory prior to delivery, and adjustment at the time of use. During designing, a magnetic head slider is designed so that when the magnetic head slider travels during continuous writing with the environmental temperature set to a maximum predictive value and the air pressure set to a minimum predictive value, the uncertainty in the travel will be rated at a lower limit and the magnetic head slider will come into contact with a magnetic disk. In other words, the designing is identical to conventional designing of a slider unaccompanied with adjustment of the flying height.

In the case of a magnetic disk drive incorporated in handheld equipment, the magnetic disk drive is subjected to a large variance in the environmental temperature. In the case of a magnetic disk drive incorporated in a server, heat dissipated from magnetic poles during continuous writing brings about thermal projection of a slider and the flying height of the slider decreases very largely. Thus, the conditions for designing vary depending on equipment to which the magnetic disk drive is adapted.

During testing at a factory prior to delivery, the flying height of each magnetic head slider is tested and stored in a memory. A flying height adjustment value is proportional to supplied power. Therefore, the supplied power is first set to zero and then gradually increased. When the contact of the slider with a disk is sensed, the supplied power at that time and the proportionality coefficient between the flying height adjustment value and supplied power are used to calculate the flying height of the magnetic head slider. Methods of sensing the contact include a method of monitoring an off-track signal (position error signal) signifying that an off-track incident has occurred because the magnetic head slider is microscopically turned on a pivot due to contact frictional force. Incidentally, not only a variance in the flying height among sliders but also differences among zones such as differences among internal, middle, and circumferential zones of a magnetic disk and a difference in the flying height between recording and reproducing may be stored in the memory. In this case, the precision in adjusting the flying height can be improved.

At the time of use, in principle, when a Read or Write instruction is received from a client such as a computer, power proportional to the flying height of a selected active magnetic head slider is supplied to the magnetic head slider alone. No power is supplied to an idle magnetic head slider. An amount of power to be supplied to the active magnetic head slider is decreased or increased according to a proportionality coefficient between a flying height adjustment value and supplied power. That is, when continuous writing proceeds or the environmental temperature is high, the amount of power to be supplied to the active magnetic head slider is decreased. When the environmental temperature is low, the amount of power to be supplied to the active magnetic head slider is increased. Information on the environmental temperature is acquired from a temperature element accompanying a magnetic disk drive.

The procedure of testing the flying height of each slider at a factory prior to delivery may be omitted. An alternative method according to an embodiment of the present invention will be described below. A target value is determined for a value indicating recording/reproducing performance such as an error rate or an overwriting frequency. While a heater-conduction current value is increased, the recording/reproducing performance is measured. If the target recording/reproducing performance is attained with a current value smaller than a limit heater-conduction current value, the current value is adopted as a current value set for the head slider. If the current value reaches the limit heater-conduction current value before the target recording/reproducing performance is attained, the product is regarded as defective and sent to a disassembling and reassembling line.

As long as a nominal value of and a variance in an original gap between a flying head and a disk, a nominal value of and a variance in a difference in environmental temperature, and a nominal value of and a variance in a difference in a flying height between recording and reproducing are statistically known, a current value can be determined so that it will permit satisfactory recording/reproducing performance while suppressing the possibility of a magnetic head slider and a magnetic disk coming into contact with each other to the greatest possible extent.

As mentioned above, according to embodiments of the present invention, two demands, that is, a demand for increasing a change in a flying height caused by heat dissipated from a heater and a demand for decreasing a change in the flying height caused by heat dissipation derived from a recording current can be met simultaneously. Consequently, low flying of a magnetic head slider and a high recording density for a magnetic disk drive can be accomplished.

While the present invention has been described with reference to specific embodiments, those skilled in the art will appreciate that different embodiments may also be used. Thus, although the present invention has been described with respect to specific embodiments, it will be appreciated that the present invention is intended to cover all modifications and equivalents within the scope of the following claims.

What is claimed is:

1. A magnetic head slider comprising:
a slider; and
a thin-film head formed on an element forming surface of the slider including a write element, a read element, a heater, and an insulating layer that separates the elements and heater from one another, wherein:
the distance from the element forming surface of the slider to the write element is smaller than the distance from the element forming surface to the read element and heater.

2. The magnetic head slider of claim 1, wherein the thin-film head has the write element and read element layered on the element forming surface, and has the heater disposed near the read element.

3. The magnetic head slider of claim 1, wherein the thin-film head has the write element and read element layered on the element forming surface, and has the heater disposed behind the read element.

4. The magnetic head slider of claim 1, wherein the thin-film head has the write element, read element, and heater layered on the element forming surface.

5. A magnetic head slider comprising:
a slider; and
a thin-film head formed on an element forming surface of the slider including a write element, an adiabatic layer, a read element, a heater, and an insulating layer that separates the elements, layer, and heater from one another, wherein:
the distance from the element forming surface of the slider to the write element is smaller than the distance from the element forming surface to the read element and heater; and
the adiabatic layer exhibits lower thermal conductivity than the insulating layer does, and is interposed between the write element and the read element and heater.

6. The magnetic head slider of claim 5, wherein the thin-film head has the write element, adiabatic layer, and read element layered on the element forming surface, and has the heater disposed near the read element.

7. The magnetic head slider of claim 5, wherein the thin-film head has the write element, adiabatic layer, and read element layered on the element forming surface, and has the heater disposed behind the read element.

8. The magnetic head slider of claim 5, wherein the thin-film head has the write element, adiabatic layer, read element, and heater layered on the element forming surface.

9. The magnetic head slider of claim 5, wherein the insulating layer is made of alumina and the adiabatic layer is made of a resin.

10. The magnetic head slider of claim 5, wherein the insulating layer is made of alumina and the adiabatic layer is made of silicon dioxide.
